(19) United States
(12) Patent Application Publication
(10) Pub. No.: US 2005/0252533 A1
(43) Pub. Date: Nov. 17, 2005

(54) Method and system for washing

(76) Inventors: Andre Cesar Baeck, Bonheiden (BE); Andre Christian Convents, Diegem (BE); Johan Smets, Lubbeek (BE); Pascale Claire Annick Van Steenwinckel, Weerde (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/130,874

(22) Filed: May 17, 2005

(30) Foreign Application Priority Data
May 17, 2004 (EP) 04252837.2

(51) Int. Cl. B08B 3/00; D06F 1/00; B08B 7/04; D06F 39/02

(52) U.S. Cl. 134/26; 8/147; 8/137; 8/158; 134/10; 134/109; 68/12.13; 68/18 F; 68/207

(57) ABSTRACT

A washing system for use in cleaning or washing a soiled substrate or substrates, the system comprising: a. a washing zone for contacting the soiled substrate with wash liquor; b. a feed supply for providing hot or cold feed water to the washing zone; c. a water-softening zone intermediate the feed supply and washing zone and in fluid communication therewith; d. an effluent storage and/or discharge zone; and e. a product dispensing zone intermediate the water softening zone and washing zone;
and wherein the water-softening zone is effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar). The water-softening zone is preferably a nanofiltration device having a cut-off in the range from about 100 to about 1000 Daltons, a clean water flux of at least 3 L/m².h.100 kp (RO water at 25° C.), and a magnesium ion rejection of at least 50%. The washing system is preferably used for washing laundry.

### CROSS REFERENCE TO RELATED APPLICATION

This application claims the benefit of EP Patent Application No. 04252837.2, filed May 17, 2004.

1. Field of the Invention

The present invention relates to methods and systems for use in cleaning or washing a soiled substrate or substrates. In particular it relates to methods and systems applicable in the field of domestic or institutional appliances such as laundry washing machines, automatic dishwashing machines, etc and which enable improved cleaning of a soiled substrate or substrates across the range of detergent usage levels. The invention also relates to methods and systems that enable more efficient usage of water, energy and detergent product resources. The invention further relates to methods and systems incorporating simple-to-use and cost effective water-softening technology.

2. Background of the Invention

In recent years there has been growing interest in a variety of non-detergent based technologies for washing laundry and other soiled substrates. For example, a number of washing machines have been launched on the Japanese and Asian markets that make use of electrolysis, ultrasonic or cavitation techniques to promote the cleaning or disinfection of laundry. Typically, such machines include at least one wash cycle characterized as ‘detergent-free’ and which is designed for the washing of laundry that is relatively lightly soiled. As the washing machine manufacturers themselves make clear, however, the machines and systems currently on the market are of limited value for the washing of more heavily soiled or stained items where the use of a surfactant-based detergent product continues to be necessary to achieve acceptable cleaning performance. Accordingly, such machines are designed and marketed for so-called ‘hybrid’ use with non-detergent and detergent wash-cycles being selectable according to the severity of the laundering task.

In terms of overall resource utilization, the non-detergent based cleaning technologies may have the potential to save on detergent product usage in light soil situations, but such savings are offset to a lesser or greater extent by the operational need for higher water and energy utilization. Thus the resource equation is finely balanced.

There are also a variety of disclosures in the patent art on the use of water-softening techniques in laundering and washing appliances. These include electrochemical, electrodeionisation, electrodialysis and electroosmosis techniques; magnetic field separation techniques; chemical flocculation techniques; and ion exchange techniques based on either conventional salt-regenerated resin technology or newer thermally-regenerating resin technology. Many of the art-suggested processes suffer problems in one or more areas, for example complexity of operation, high energy usage, high costs, poor flow rates, short life cycle, inefficient use of chemicals, etc.

It clearly would be desirable to enhance the efficacy of current washing machines and systems, including the newer ‘hybrid’ machines, so as to deliver improved washing performance across the full range of detergent usage levels. It would also be desirable to deliver performance improvements in the context of an overall efficient and sustainable utilization of resources—chemical, water and energy. It would furthermore be desirable to develop cost-effective water-softening technology suitable for use in conjunction with domestic washing appliances and systems and which address the above problems of complexity, energy usage, flow rate, life cycle, etc.

It is an object of the present invention therefore to provide methods and systems applicable in the field of domestic or institutional appliances and in particular laundry washing machines, and which enable improved cleaning of a soiled substrate or substrates across the range of detergent usage levels. It is another object of the invention to provide washing methods and systems enabling more efficient usage of water, energy and detergent product resources. It is a further object of the invention to provide washing methods and systems incorporating simple-to-use, cost-effective water-softening technology with acceptable usage characteristics and lifetime sustainability. It is an additional object of the invention to provide efficient washing solutions by combining the hereindescribed methods and systems with state of the art detergent compositions.

### SUMMARY OF THE INVENTION

According to a first aspect of the present invention, there is provided a washing system for use in the laundering of fabrics or for the cleaning or washing of a soiled substrate or substrates. The washing system generally comprises a washing zone for contacting the fabrics or soiled substrates with wash liquor; a feed supply for providing hot or cold feed water to the washing zone; a water-softening zone intermediate the feed supply and washing zone and in fluid communication therewith; an effluent storage and/or discharge zone; and a product dispensing zone (sometimes referred to herein as ‘the dispensing zone’) intermediate the water softening zone and the washing zone. The washing zone can be dual purpose and also function as a post-wash rinsing zone; alternatively the wash system can optionally comprise a separate post-wash rinsing zone. The dispensing zone preferably comprises means for dosing detergent and/or fabric enhancer product into the pre-softened feed water within or on the feed water inlet to the washing zone or post-wash rinsing zone and may also comprise storage means, for example, a bottle-shaped storage container or a replacement pack for bulk detergent and/or fabric enhancer product. In addition, the dispensing means will generally comprise means enabling filling, refilling or replacement of the product storage means and may in addition comprise valves, dispensing orifices or other means for metering or for controlling the dosing rate of the detergent and/or fabric enhancer product relative to the soft water flux of the water-softening zone. Preferably the dispensing and water-softening zones are serially-connected or comprise an integral water-softening and product-dispensing unit, i.e. a unit having separate but interconnected water-softening and product-dispensing zones, the product-dispensing zone being downstream of the water-softening zone and comprising means for dosing product into the feed water on the output side of the water-softening zone.

Unless otherwise clear from the context, the term ‘product’ as used herein encompasses both active-based detergent compositions suitable for washing and cleaning of soiled substrates and auxiliary compositions suitable for use after washing or in conjunction with active-based detergents and designed to provide an ancillary substrate benefit or effect, for example, finishing agents, rinsing agents, fabric enhancers designed to provide post-wash fabric care or aesthetic benefits, and detergent auxiliaries designed to provide post-wash surface care or aesthetic benefits. The terms ‘product dispensing zone’, ‘product storage means’ etc should be construed accordingly.

Water-softening zones suitable for use in the systems and methods of the invention include a variety of membrane-based or electroseparation techniques including electrodeionisation, electrodialysis, reverse-osmosis and ion-exchange. Preferably however, the water-softening zone comprises comprises a filtration device, and more especially a nanofiltration device. The water softening zone is preferably effective to soften the water to a residual Ca²⁺ hardness of 1 mmol/L or less with a soft water flux of at least about 2 L/h, more preferably at least about 10 L/h at a feed water pressure in the range from about 100 to about 1000 kP (1-10 bar), preferably from about 100 to about 400 kP (1-4 bar).

Filtration devices suitable for use herein preferably takes the form of a cross-flow device with feed water input, retentate recirculation, hard-water effluent bleed and optional recirculation pump. Preferably the flux ratio of soft-water permeate to hard-water effluent developed by the filtration device is at least about 1:1, preferably at least about 3:1, more preferably at least about 5:1, and especially at least about 8:1.

In highly preferred embodiments the water-softening zone comprises a nanofiltration device having a cut-off in the range from about 100 to about 1000 Daltons, preferably from about 200 to about 1000 Daltons. The clean water flux of the device, on the other hand, is preferably at least 3, more preferably at least 6 L/m².h.100 kp (RO water at 25° C.). The device preferably also has a magnesium ion rejection of at least 50%, more preferably at least 80% (0.35 wt % MgSO₄, 600 kP, Re=2500, 25° C.).

Thus in another aspect of the invention, there is provided a washing system for use in cleaning or washing a soiled substrate or substrates, the system comprising:
a. a washing zone for contacting the soiled substrate with wash liquor;
b. a feed supply for providing hot or cold water to the washing zone;
c. a water-softening zone intermediate the feed supply and washing zone and in fluid communication therewith;
d. an effluent storage or discharge zone; and optionally
e. a product dispensing zone intermediate the water softening zone and washing zone;
   and wherein the water-softening zone comprises a nanofiltration device having a cut-off in the range from about 100 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.).

Where present, the product dispensing zone preferably comprises means for dosing detergent and/or detergent auxiliary product into the softened feed water within or on the feed water inlet to the washing zone and/or post-wash rinsing zone and may also comprise storage means for detergent and/or detergent auxiliary product, for example, a bottle-shaped storage container or a replacement pack for bulk detergent and/or detergent auxiliary product. In addition, the product dispensing zone will generally comprise means enabling filling, refilling or replacement of the product storage means and may in addition comprise valves, dispensing orifices or other means for metering or for controlling the dosing rate of the detergent and/or detergent auxiliary product relative to the soft water flux of the water-softening zone. Preferably the dispensing and water-softening zones are serially-connected or comprise an integral water-softening and product-dispensing unit, i.e. a unit having separate but interconnected water-softening and product-dispensing zones, the product-dispensing zone being downstream of the water-softening zone and comprising means for dosing product into the feed water on the output side of the water-softening zone.

The filtration device preferred for use herein is a cross-flow device having permeate and retentate outlet ports, the permeate outlet port being in fluid communication with the washing zone and the retentate outlet port being in fluid communication with one or more of the effluent storage and discharge zones.

In the systems and methods of the invention, the feed supply supplies water directly from the mains, from a mains or used-water reservoir, or from a combination thereof. Where the water is supplied from a reservoir, the filtration device will normally comprise a recirculation pump. In the case of mains water supply, the recirculation pump is optional and it is a feature of the invention that the washing system can, depending upon mains pressure, perform satisfactorily without the need for a recirculation pump.

Downstream of the water-softening zone and in fluid communication therewith, the washing system can additionally comprise an inlet reservoir for storing and delivering hot or cold softened mains water to the washing zone.

In systems and methods of the invention comprising a post-wash rinsing zone separate to the washing zone, the feed supply and inlet reservoir can additionally serve to supply hot or cold softened water to the rinsing zone. Similarly, the water-softening zone, and in particular the permeate outlet port of the filtration device, can also be in fluid communication with the rinsing zone.

The washing systems of the invention can take the form of an integral water-softening and washing appliance wherein the water-softening zone and washing zone are built into and form part of a single appliance with the two zones in fluid communication with one another via the conduits of the appliance. In preferred embodiments, however, the washing system comprises a water-softening appliance and a washing appliance in hyphenated form, whereby the water-softening appliance and its associated water-softening zone forms a stand-alone unit that can be either permanently or temporarily fitted to the feed water inlet conduits of the washing appliance as required by the user, any power supply required for the water-softening appliance being taken either from the power supply for the washing appliance or separately from the mains power supply.

According to a further aspect of the invention therefore, there is provide a water-softening appliance comprising a nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.). The nanofiltration device is preferably a cross-flow device with mains feed water input, retentate recirculation, hard-water effluent bleed and optional recirculation pump whereby the flux ratio of soft-water permeate to hard-water effluent is at least about 1:1, preferably at least about 3:1, more preferably at least about 5:1, and especially at least about 8:1.

In a method aspect of the invention, there is provided a method for laundering fabrics using a washing system comprising:
a. a washing zone for contacting the fabrics with wash liquor;
b. a feed supply for providing hot or cold feed water to the washing zone;
c. a water-softening zone intermediate the feed supply and washing zone and in fluid communication therewith, the water-softening zone comprising a filtration device effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar);
d. an effluent storage and/or discharge zone; and
e. a product dispensing zone intermediate the water softening zone and washing zone;
   the method comprising i) a water softening step wherein the feed water is softened in the water softening zone, ii) a detergent dispensing step wherein an active detergent product is dosed in a cleaning-effective amount into the softened feed water within the feed water inlet to the washing zone, iii) a washing step wherein the fabrics are contacted with the resulting wash liquor, and optionally iv) a fabric enhancer dispensing step wherein a fabric enhancer providing a post-wash fabric care or aesthetic benefit is dosed into the softened feed water within the feed water inlet to the washing zone or a post-wash rinsing zone, and v) a rinsing step wherein the fabrics are contacted with the resulting rinse liquor. Suitable fabric enhancers include perfumes and other olfactory agents, textile softening agents, ironing aids, antibacterial agents, anti-pilling aids, etc well-known per se.

In highly preferred methods herein the water-softening zone comprises a nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.).

Thus according to another method aspect of the invention, there is provided a method for cleaning or washing a soiled substrate or substrates using a washing system comprising:
a. a washing zone for contacting and washing the soiled substrate with wash liquor;
b. a feed supply for providing hot or cold feed water to the washing zone;
c. a water-softening zone intermediate the feed supply and washing zone and in fluid communication therewith, the water-softening zone comprising a nanofiltration device effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar), the nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.);
d. an effluent storage and/or discharge zone; and optionally
e. a product dispensing zone intermediate the water softening zone and washing zone;
   the method comprising i) a water softening step wherein the feed water is softened in the water softening zone, ii) an optional detergent dispensing step wherein an active detergent product is dosed into the softened feed water within the feed water inlet to the washing zone and iii) a washing step wherein the soiled substrate is contacted with wash liquor obtained from the softened feed water.

In addition, the method preferably further comprises iv) a detergent auxiliary dispensing step wherein a detergent auxiliary product providing a post-wash surface care or aesthetic benefit is dosed into the softened feed water within the feed water inlet to the washing zone or a post-wash rinsing zone, and v) a rinsing step wherein the substrate is contacted with the resulting rinse liquor. Suitable detergent auxiliaries include perfumes, textile softening agents, ironing aids, anti-pilling aids, hard surface shine aids, etc well-known per se.

In preferred methods of the invention, the washing step is undertaken at a detergent product wash liquor concentration in the range from about 0 to about 2% by weight, preferably from about 0 to about 1% by weight, more preferably from about 0 to about 0.5% by weight, and especially from about 0 to about 0.25% by weight. Typically, however, the detergent product will be present in a cleaning-effective amount, ie. an amount effective to improve the cleaning end-result over and above the end-result achieved in the absence of detergent. Generally, the detergent product will normally be present in a level of at least 0.1% by weight of the wash liquor. Suitably the wash liquor pH during the washing step is in the range from about 5 to about 13, preferably from about 6 to about 12, more preferably from about 7 to about 11. The temperature of the wash liquor during the washing step, on the other hand, can vary broadly across the full range of temperature usage conditions known in the art but preferably the wash temperature is no more than about 30° C., this being preferred from the viewpoint of energy reduction and being made possible by the inclusion of a water-softening zone as set out in the present invention. In methods comprising the use of detergency enzymes such as proteases, cellulases and amylases, the enzyme concentration during the washing step is preferably from about 0.0001 to about 100 ppm of active enzyme. A non-limiting list of enzymes suitable for use herein is disclosed in, for example, US2002/0155971.

It is a feature of the invention that by incorporating a water-softening zone intermediate the feed supply and washing zone, it makes possible the design and use of a range of soft-water detergents which are especially effective or efficient in cleaning soiled substrates under soft-water conditions. Moreover, by integrating the product dispensing and water-softening zones in a serially-connected or unitary device, it becomes possible to ensure usage compliance, ie. to ensure that the soft water detergent is used only under the appropriate soft water conditions.

Filtration devices preferred for use herein as part of the water-softening zone or appliance take the form of a module comprising a filter housing provided with a membrane compartment in which is mounted a bundle of capillary or tubular filtration membranes, the ends of which are encased in membrane holders and which communicate with one or more inlet ports and one or more retentate outlet ports. The filter housing is also provided with one or more openings in the wall of the filter housing and which communicate with one or more permeate outlet ports. Hot or cold water from the feed supply enters the filter housing via a connection into the inlet port and then passes through the capillary or tubular filtration membranes, the resulting retentate and permeate being discharged through connections into the corresponding retentate and permeate outlet ports. Such an arrangement is referred to herein as an ‘inside-out’ arrangement.

Alternatively, the module can be operated in reverse manner (‘outside-in’) wherein the feed water is supplied and the retentate discharged via openings in the wall of the filter housing communicating with corresponding inlet and retentate outlet port connections. In this case permeate is collected within the filtration membranes and discharged via their open ends and corresponding permeate outlet port connections.

The module can also be provided with one or more distributor pipes placed transverse to the direction of the filtration membranes with one or more openings into the membrane compartment in order to reduce the transverse forces on the filtration membranes, such an arrangement being described in detail in WO-A-98/20962.

Preferred for use herein is a filtration device or module based on a polyamide/polyethersulfone nanofiltration membrane developed for inside-out filtration marketed by X-Flow B.V. under the designation NF50M10.

Nanofiltration membranes can be prone to degradation or attack by chlorine in feed water. Accordingly the filtration device may be used in conjunction with a chlorine removal system such as a carbon prefilter, an antioxidant or brass in order to extend the working life of the device.

The filtration device is preferably provided with a recirculation loop interconnecting the retentate outlet and inlet ports together with a one-way recirculation valve for purposes of providing controlled recirculation of retentate through the filtration module. The recirculation loop is also provided with an effluent bleed connection and a one-way bleed valve for purposes of bleeding hard water effluent out of the recirculation loop. The recirculation and effluent bleed valves are preferably set such that the flux ratio of soft-water permeate to hard-water effluent is at least about 1:1, preferably at least about 3:1, more preferably at least about 5:1, and especially at least about 8:1.

The filtration device preferably also comprises a pump for recirculating the retentate stream through the filtration module under elevated pressure, the pump either being situated in the recirculation loop with the sole or primary purpose of retentate recirculation or else being operatively connected to the main discharge pump of the washing appliance or washing zone.

The product dispensing zone can be integrated into and form part of a washing appliance as known for example in conventional domestic laundry washing machines. In other embodiments, however, the dispensing zone forms a separate unit which connects into the washing appliance via an external conduit. In this case a water-softening device such as the filtration module described above can be serially-connected to the product dispensing unit via one or more conduits leading from the outlet port or ports of the device to the inlet port of the dispensing unit. Preferably, however, the dispensing unit is provided either as a detachable attachment or built into an integral water-softening and product-dispensing module and is interconnected to the water-softening zone via one or more internal conduits of the module. One or more separate refillable or replaceable product storage means suitable for storing an active detergent and/or an auxiliary detergent product for finishing or for purposes of providing post-wash fabric- or surface-care or aesthetic benefits can be provided connecting via corresponding conduits to the dispensing orifice or orifices of the dispensing unit, but again preferably the one or more product storage means is provided either as a detachable attachment or built into the water-softening and product-dispensing module, product being dispensed into a soft water outlet manifold region of the module via a respective dispensing orifice optionally equipped with valve means to regulate the flow of product.

Detergent compositions suitable for use in the washing systems and methods of the invention include the conventional built or unbuilt solid and liquid surfactant-based detergent compositions well known for use in both heavy and light duty cleaning operations including laundering, dishwashing and other hard surface applications, etc. It is a feature of the invention, however, that by virtue of the pre-softening of the feed water and removal of hardness therefrom, it becomes possible to achieve acceptable cleaning of substrates at lower detergent usage levels than otherwise would be required. By virtue of pre-softening of the feed water, it also becomes possible to achieve post-wash surface-care and aesthetic benefits in a more efficient and effective manner. It also becomes possible to ensure usage compliance in respect of detergent and/or detergent auxiliary products that are designed to provide optimum cleaning and/or finishing under soft-water conditions, for example, detergents containing relatively low levels of surfactants, detergency builders and/or builder auxiliaries such as anti-incrustation agents and soil suspending agents, or detergents containing low levels of these ingredients combined with relatively high levels of detergency enzyme active ingredients.

1. A washing system for use in the laundering of fabrics comprising:
a. a washing zone for contacting the fabrics with wash liquor;
b. a feed supply for providing hot or cold feed water to the washing zone;
c. a water-softening zone intermediate the feed supply and washing zone and in fluid communication therewith;
d. an effluent storage and/or discharge zone; and
e. a product dispensing zone intermediate the water softening zone and washing zone;
and wherein the water-softening zone is effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar).

2. A washing system according to claim 1 wherein the product dispensing zone comprises means for dosing detergent and/or fabric enhancer product into the softened feed water within the feed water inlet to the washing zone or to a post-wash rinsing zone, the dispensing zone preferably also comprising storage means for detergent and/or fabric enhancer product and means enabling filling, refilling or replacement of the product storage means.

3. A washing system according to claim 1 or 2 wherein the dispensing and water-softening zones are serially-connected or comprise an integral water-softening and product-dispensing unit.

4. A washing system according to any of claims 1 to 3 wherein the water-softening zone comprises one or more water-softening devices selected from nanofiltration, electrodeionisation, electrodialysis, reverse-osmosis and ion-exchange water-softening devices and combinations thereof.

5. A washing system according to any of claims 1 to 4 wherein the water-softening zone comprises a cross-flow filtration device with feed water input, retentate recirculation, hard-water effluent bleed and optional recirculation pump whereby the flux ratio of soft-water permeate to hard-water effluent is at least about 1:1, preferably at least about 3:1, more preferably at least about 5:1, and especially at least about 8:1.

6. A washing system according to any of claims 1 to 5 wherein the water-softening zone comprises a nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.).

7. A washing system for use in cleaning or washing a soiled substrate or substrates, the system comprising:
a. a washing zone for contacting the soiled substrate with wash liquor;
b. a feed supply for providing hot or cold water to the washing zone;
c. a water-softening zone intermediate the feed supply and washing zone and in fluid communication therewith; and
d. an effluent storage or discharge zone; and optionally
e. a product dispensing zone intermediate the water softening zone and washing zone;
and wherein the water-softening zone comprises a nanofiltration device having a cut-off in the range from about 100 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.).

8. A washing system according to claim 7 wherein the product dispensing zone comprises means for dosing detergent and/or detergent auxiliary product into the softened feed water within the feed water inlet to the washing zone or to a post-wash rinsing zone, the dispensing zone preferably also comprising storage means for detergent and/or detergent auxiliary product and means enabling filling, refilling or replacement of the product storage means.

9. A washing system according to claim 7 or 8 wherein the dispensing zone and water-softening zone comprise an integral water-softening and product-dispensing unit.

10. A washing system according to any of claims 7 to 9 wherein the nanofiltration device is effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar)

11. A washing system according to any of claims 7 to 10 wherein the nanofiltration device is a cross-flow device with feed water input, retentate recirculation, hard-water effluent bleed and optional recirculation pump whereby the flux ratio of soft-water permeate to hard-water effluent is at least about 1:1, preferably at least about 3:1, more preferably at least about 5:1, and especially at least about 8:1.

12. A washing system according to any preceding claim wherein the water-softening zone comprises a cross-flow filtration device having permeate and retentate outlet ports, the permeate outlet port being in fluid communication with the washing zone and the retentate outlet port being in fluid communication with one or more of the effluent storage or discharge zones.

13. A washing system according to any preceding claim wherein the feed supply supplies water directly from the mains, from a mains or used-water reservoir, or from a combination thereof.

14. A washing system according to any preceding claim additionally comprising an inlet reservoir in fluid communication with the water-softening zone for storing and delivering hot or cold softened mains water to the washing zone.

15. A washing system according to any preceding claim in the form of an integral water-softening and washing appliance or wherein the washing system comprises a water-softening appliance and a washing appliance in hyphenated form.

16. A washing system according to any of claims 7 to 15 for use in the laundering of fabrics.

17. A water-softening appliance comprising a nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 wt % MgSO₄, 600 kP, Re=2500, 25° C.), the nanofiltration device being a cross-flow device with mains feed water input, retentate recirculation, hard-water effluent bleed and optional recirculation pump whereby the flux ratio of soft-water permeate to hard-water effluent is at least about 1:1, preferably at least about 3:1, more preferably at least about 5:1, and especially at least about 8:1.

18. A method for laundering fabrics using a washing system comprising:
a. a washing zone for contacting the fabrics with wash liquor;
b. a feed supply for providing hot or cold feed water to the washing zone;
c. a water-softening zone intermediate the feed supply and washing zone and in fluid communication therewith, the water-softening zone being effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar);
d. an effluent storage and/or discharge zone; and
e. a product dispensing zone intermediate the water softening zone and washing zone;
the method comprising i) a water softening step wherein the feed water is softened in the water softening zone, ii) a detergent dispensing step wherein an active detergent product is dosed in a cleaning-effective amount into the softened feed water within the feed water inlet to the washing zone, and iii) a washing step wherein the fabrics are contacted with the resulting wash liquor.

19. A method according to claim 18 further comprising iv) a fabric enhancer dispensing step wherein a fabric enhancer product providing a post-wash fabric care or aesthetic benefit is dosed into the softened feed water within the feed water inlet to the washing zone or a post-wash rinsing zone, and v) a rinsing step wherein the fabrics are contacted with the resulting rinse liquor.

20. A method for cleaning or washing a soiled substrate or substrates using a washing system comprising:
a. a washing zone for contacting and washing the soiled substrate with wash liquor;
b. a feed supply for providing hot or cold feed water to the washing zone;
c. a water-softening zone intermediate the feed supply and washing zone and in fluid communication therewith, the water-softening zone comprising a nanofiltration device effective to soften the water to a residual Ca²⁺ hardness of 1 mmol/L or less with a soft water flux of at least about 2 L/h, preferably at least about 10 L/h at a feed water pressure in the range from about 100 to about 1000 kP (1-10 bar), preferably from about 100 to about 400 kP (1-4 bar), the nanofiltration device having a cut-off in the range from about 100 to about 1000 Daltons, preferably from about 200 to about 1000 Daltons, a clean water flux of at least 3, preferably at least 6 L/m².h.100 kp (RO water at 25° C.), and a magnesium ion rejection of at least 50%, preferably at least 80% (0.35 Wt % MgSO₄, 600 kP, Re=2500, 25° C.); and
d. an effluent storage and/or discharge zone; and optionally
e. a product dispensing zone intermediate the water softening zone and washing zone;
the method comprising i) a water softening step wherein the feed water is softened in the water softening zone, ii) an optional detergent dispensing step wherein an active detergent product is dosed into the softened feed water within the feed water inlet to the washing zone and iii) a washing step wherein the soiled substrate is contacted with wash liquor obtained from the softened feed water.

21. A method according to claim 19 further comprising iv) a detergent auxiliary dispensing step wherein a detergent auxiliary product providing a post-wash surface care or aesthetic benefit is dosed into the softened feed water within the feed water inlet to the washing zone or a post-wash rinsing zone, and v) a rinsing step wherein the substrate is contacted with the resulting rinse liquor.

22. A method according to any of claims 18 to 21 wherein the washing step is undertaken at a detergent product wash liquor concentration in the range from about 0.1% to about 2% by weight, preferably from about 0.1% to about 1% by weight, more preferably from about 0.1% to about 0.5% by weight, and especially from about 0.1% to about 0.25% by weight.

23. A method according to any of claims 18 to 22 wherein the washing step is undertaken at a wash liquor pH in the range from about 5 to about 13, preferably from about 6 to about 12, more preferably from about 7 to about 11.

24. A method according to any of claims 18 to 23 wherein the washing step is undertaken at a wash temperature of no more than about 30° C.

25. A method according to any of claims 18 to 24 wherein the washing step is undertaken at a detergency enzyme concentration in the range from about 0.0001 to about 100 ppm of active enzyme.

26. A method according to any of claims 18 to 25 comprising the use of a washing system or appliance according to any of claims 1 to 17.

27. A cleaning solution comprising softened feed water obtained using the wash system or appliance of any of claims 1 to 17 or made by the method of any of claims 18 to 26, said softened feed water additionally comprising a cleaning-effective amount of a detergent composition.
